(19) United States
(12) Patent Application Publication
(10) Pub. No.: US 2013/0104101 A1
(43) Pub. Date: Apr. 25, 2013

(54) SEQUENCE PROGRAM CREATING APPARATUS

(71) Applicants: Takayuki Yamaoka, Chiyoda-ku (JP); Terumasa Yasui, Chiyoda-ku (JP); Hirofumi Kai, Chiyoda-ku (JP)

(72) Inventors: Takayuki Yamaoka, Chiyoda-ku (JP); Terumasa Yasui, Chiyoda-ku (JP); Hirofumi Kai, Chiyoda-ku (JP)

(73) Assignee: MITSUBISHI ELECTRIC CORPORATION, Chiyoda-ku, Tokyo (JP)

(21) Appl. No.: 13/519,207

(22) PCT Filed: Sep. 16, 2011
(86) PCT No.: PCT/JP11/71207

§ 371 Date: Jun. 26, 2012

(51) Int. Cl. G06F 9/44

(52) U.S. Cl. CPC G06F 8/30
USPC 717/113

(57) ABSTRACT

A sequence program creating apparatus creates a sequence program to be executed by a programmable logic controller by causing a user to perform an operation of editing a sequential function chart (SFC) expressed by a plurality of elements and a connecting state thereof on an editing screen. The sequence program creating apparatus includes: a rule storage unit that stores therein a code of the SFC; and an editing control unit that, when a new-element inserting operation for newly inserting the element into the SFC is performed on the editing screen, adds data corresponding to the new element to data of the sequence program, based on a type of the already-arranged element specified as a new-element insertion target element by the new-element inserting operation, a position with respect to the new-element insertion target element, and a code of the SFC stored in the rule storage unit.

### FIELD

The present invention relates to a sequence program creating apparatus that creates a program of a programmable logic controller by editing a sequential function chart (SFC).

### BACKGROUND

There is known a sequential function chart (SFC) as a description method of a program used for creating a sequential program executed by a programmable logic controller. The SFC is a method of representing a processing flow similar to a flowchart by figurative elements and a connecting state thereof. The SFC has features such that, for example, a workflow is easy to understand.

Essentially, the SFC is a chart that represents a relation of a connection between steps and transitions by a drawing. In the IEC standard, a text representation that directly describes a relation of a connection is defined in parallel with a graphical representation.

Conventionally, graphical constituent elements such as connection lines of steps, transitions, branches, and convergences are arranged on a grid to create a program. An operation of arranging these constituent elements requires time and labor, because a plurality of parts are necessary to be arranged to represent a simple relation, and even graphical representations that make no sense as the SFC is made, thereby degrading the efficiency of production.

In Patent Literature 1, a transition is automatically inserted between steps by using such a code that steps and transitions appear alternately.

In Patent Literature 2, wrong inputs are rejected by using “insertion judgment matrix that limits insertable functional parts in advance” preset at the time of an input operation.

### CITATION LIST

### Patent Literatures

Patent Literature 1: Japanese Patent Application Laid-open No. H05-341816
Patent Literature 2: Japanese Patent Application Laid-open No. H11-296357

### SUMMARY

### Technical Problem

However, in the technique of Patent Literature 1, when steps are continuously inserted, insertion of transitions can be omitted; however, effective cases for this operation are limited. For example, at the time of inserting a step after a parallel branch, it cannot be determined whether to insert a transition. Furthermore, when a step is newly arranged after a selective branch, which has not been converged, it cannot be determined whether to connect the new step by inserting a transition between the last step at one branching point and the new step or to connect it as a selective convergence by inserting a transition between the last steps at all branching points and the new step.

In the technique of Patent Literature 2, when a restriction by an SFC code is expressed as “insertion judgment matrix”, a similar function can be realized by the SFC, and it is possible to prevent performing of wrong editing that makes no sense as the SFC. However, there is a problem that editing man-hours cannot be reduced.

The present invention has been achieved in view of the above problems, and an object of the present invention is to provide a sequence program creating apparatus that can create a sequence program by editing an SFC in which elements are arranged according to a code with less man-hours.

### Solution to Problem

In order to solve the above problem and in order to attain the above object, in a sequence program creating apparatus that creates a sequence program to be executed by a programmable logic controller by causing a user to perform an operation of editing a sequential function chart (SFC) expressed by a plurality of elements and a connecting state thereof on an editing screen, the sequence program creating apparatus of the present invention, includes: a rule storage unit that stores therein a code of the SFC; and an editing control unit that, when a new-element inserting operation for newly inserting the element into the SFC is performed on the editing screen, adds data corresponding to the new element to data of the sequence program, based on a type of the already-arranged element specified as a new-element insertion target element by the new-element inserting operation, a position with respect to the new-element insertion target element, and a code of the SFC stored in the rule storage unit.

### Advantageous Effects of Invention

The sequence program creating apparatus according to the present invention can create a sequence program by arranging elements in an SFC according to a code with less man-hours.

### BRIEF DESCRIPTION OF DRAWINGS

FIG. 1 depicts a configuration of a sequence program creating apparatus according to a first embodiment of the present invention.

FIG. 2 is an example of a connection between steps and a transition.

FIG. 3 is an example of progress of processing in an SFC.

FIG. 4 is an example of selective branches and selective convergences.

FIG. 5 is an example of parallel branches and parallel convergences.

FIG. 6 is an example of a display in a display unit of an SFC constituted by elements arranged in a tree structure.

FIG. 7 is an example of an SFC drawing including steps appearing several times.

FIG. 8 is an example of a drawing of a step including a plurality of preceding transitions.

FIG. 9 is a definition example of a relevant position in an operation.

FIG. 10 is an example of a table that defines a correspondence between a gesture and an action.

FIG. 11 is a flowchart of a processing flow when insertion of a new element is performed without specifying an element type.

FIG. 12 is an example of an SFC to be displayed on a display unit by a display control unit based on a processing result when a new-element inserting operation is performed on a same position.

FIG. 13 is an example of an SFC to be displayed on the display unit by the display control unit based on a processing result when a new-element inserting operation is performed on a posterior position.

FIG. 14 is an example of an SFC to be displayed on the display unit by the display control unit based on a processing result when a new-element inserting operation is performed on an anterior position.

FIG. 15 is an example of an SFC to be displayed on the display unit by the display control unit based on a processing result when a new-element inserting operation is performed on a left position.

FIG. 16 is an example of an SFC to be displayed on the display unit by the display control unit based on a processing result when a new-element inserting operation is performed on a right position.

FIG. 17 is an example of a connecting process of already-arranged elements.

FIG. 18 is another example of the connecting process of the already-arranged elements.

FIG. 19 is an example of an SFC editing screen.

FIG. 20 is a screen transition example in a sequence program creating apparatus according to the embodiment.

FIG. 21 is a screen transition example in a conventional sequence program creating apparatus.

FIG. 22 is an example in which a cell is divided into a plurality of areas to define a relevant position.

FIG. 23 is an example in which a relevant position is allocated to an adjacent cell.

### DESCRIPTION OF EMBODIMENTS

Exemplary embodiments of a sequence program creating apparatus according to the present invention will be explained below in detail with reference to the accompanying drawings. The present invention is not limited to the embodiments.

### First Embodiment

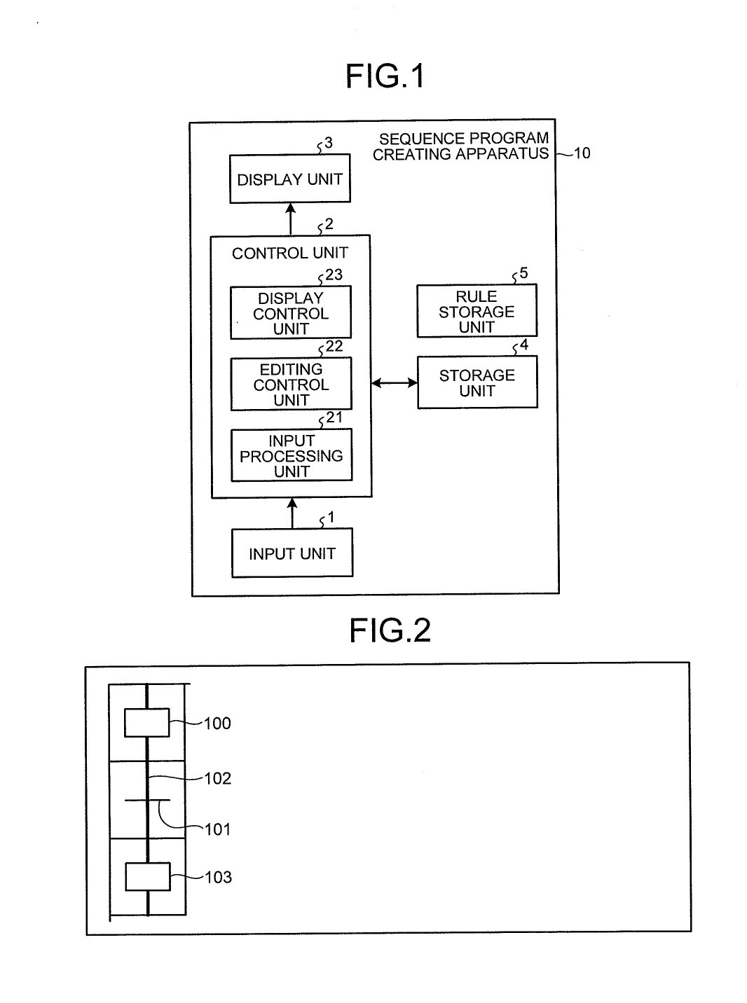

FIG. 1 depicts a configuration of a sequence program creating apparatus according to a first embodiment of the present invention. A sequence program creating apparatus 10 according to the first embodiment includes an input unit 1, a control unit 2, a display unit 3, a storage unit 4, and a rule storage unit 5. The input unit 1 is a user interface for a user to perform operations, and a keyboard, a pointing device, or a touch panel can be applied thereto. The display unit 3 is a device that displays an SFC, and an LCD or an organic liquid crystal panel can be applied thereto. The storage unit 4 includes a storage area to be used by the control unit 2 as a work area, and stores therein data of a program created by editing an SFC (edit data). The rule storage unit 5 stores therein an SFC code and the like in a nonvolatile manner. The control unit 2 includes an input processing unit 21, an editing control unit 22, and a display control unit 23. The input processing unit 21 specifies processing contents performed by the input unit 1. The editing control unit 22 performs processing such as adding an element to the edit data or replacing the element. The display control unit 23 modifies an SFC based on the edit data and displays the modified SFC on the display unit 3.

Before explaining operations of the sequence program creating apparatus 10, an SFC code required for explaining these operations is explained. The SFC code is stored in the rule storage unit 5, and the editing control unit 22 determines the processing contents to be added to the edit data according to the SFC code.

Elements that constitute an SFC are steps and transitions. Steps and transitions include an inlet and an outlet, and an outlet of a step is connected to an inlet of a transition and an outlet of a transition is connected to an inlet of a step, respectively, by a connection line. Therefore, steps and transitions appear alternately, and thus steps are not connected with each other and transitions are not connected with each other. In each diagram used for the following explanations, a step is expressed by a rectangular sign and a transition is expressed by a crossbar-shaped sign.

FIG. 2 is an example of a connection between steps and a transition. As shown in FIG. 2, when an outlet of a step 100 is connected to an inlet of a transition 101 by a connection line 102, it is described such that the transition 101 follows the step 100, and that the step 100 precedes the transition 101. Therefore, in FIG. 2, the transition 101 precedes a step 103, and the step 103 follows the transition 101.

The step is accompanied with a process written in another language (such as a ladder language). As an example, such a process that “if a device M0 is on, turn on a device M1” is accompanied with the step. Because an object of an SFC is to control an FA device, in many cases, the process is a reference to a device value (reading of a sensor value) and a change (turning on or off of a switch).

Steps have two states of active and inactive. The accompanying process is performed during an active state. Furthermore, there is a step automatically performed at the time of starting a system, and this step is referred to as “initial step”.

The transition is accompanied with a transition condition written in another language. As an example, there is such a transition condition that “when a device M2 is on and a device M3 is on, the condition is established”.

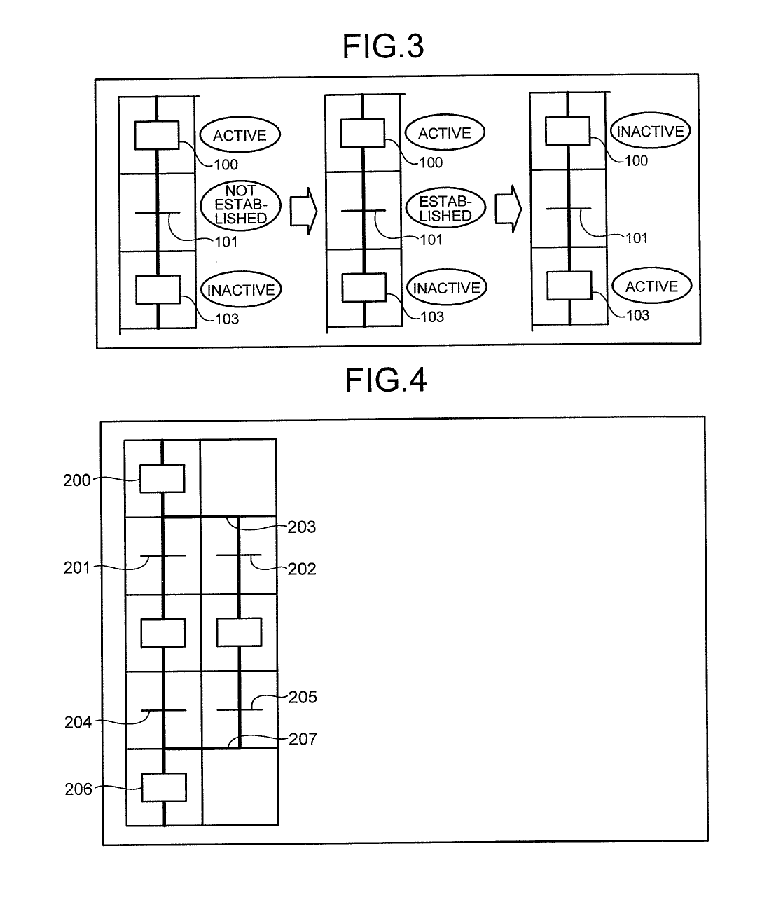

FIG. 3 is an example of progress of processing in an SFC. In FIG. 3, when the step 100 preceding the transition 101 is active, the transition condition of the transition 101 is evaluated, and when the condition is established, a transition occurs. When a transition occurs, the preceding step 100 becomes inactive, and the step 103 following the transition 101 becomes active.

There is a case where a plurality of transitions follow one step, which is referred to as “selective branch”. Furthermore, there is a case where a plurality of transitions precede one step, which is referred to as “selective convergence”. The selective branch and the selective convergence are expressed as one horizontal line connecting the inlet and outlet of the transitions on the SFC. FIG. 4 is an example of selective branches and selective convergences. An outlet of a step 200 is connected to respective inlets of a transition 201 and a transition 202 via a selective branch 203. Furthermore, respective outlets of a transition 204 and a transition 205 are connected to an inlet of a step 206 via a selective convergence 207.

When a step is active, the condition of a subsequent transition is evaluated. However, the conditions of the subsequent transitions in the selective branch are evaluated on the SFC sequentially from the left, and only a step following a transition with the condition thereof being established becomes active. Therefore, there is an order in the transitions following a certain step. In the following explanations, this order is referred to as “subsequent transition order”. In the selective convergence, a step subsequent thereto is only one, and thus when the preceding step is active and the condition is established, a transition to the subsequent step occurs.

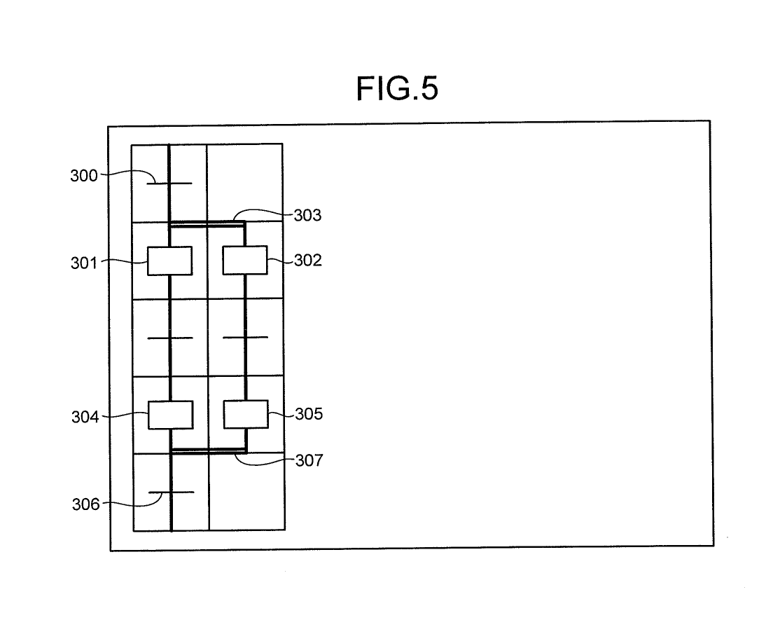

Contrary to the case of the selective branch, there is a case where a plurality of steps follow one transition, which is referred to as “parallel branch”. Contrary to the case of the selective convergence, there is a case where a plurality of steps precede one transition, which is referred to as “parallel convergence”. The parallel branch and the parallel convergence are expressed by a horizontal double line connecting an inlet and an outlet of steps on an SFC. FIG. 5 is an example of parallel branches and parallel convergences. An outlet of a transition 300 is connected to inlets of a step 301 and a step 302 via a parallel branch 303. Furthermore, respective outlets of a step 304 and a step 305 are connected to an inlet of a transition 306 via a parallel convergence 307.

In the parallel branch, when the transition condition of a transition is established, all subsequent steps become active. In the parallel convergence, a transition occurs only when all the preceding steps are active and the transition condition of a subsequent transition is established.

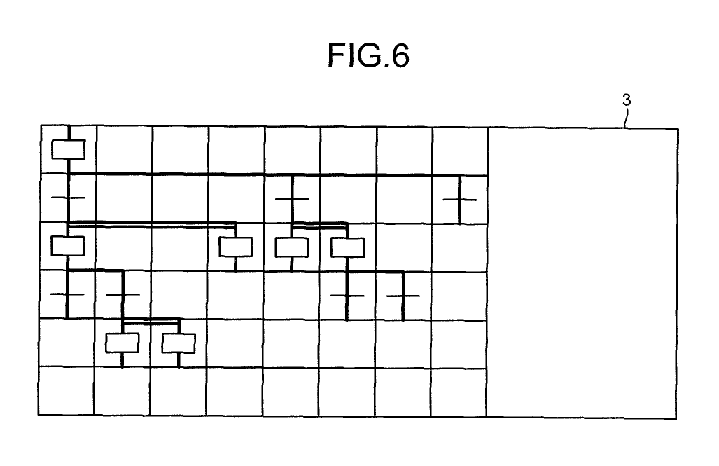

An operation of the display control unit 23 is explained next. The display control unit 23 creates an SFC based on a relation of a connection between steps and transitions. First, the display control unit 23 arranges an initial step, and then arranges transitions connected to an outlet of the initial step below (after) the initial step from left to right according to the subsequent transition order. When there are a plurality of transitions, these transitions are horizontally connected by a selective branch. Subsequently, the display control unit 23 arranges a step connected an outlet of each of the transitions below the transition. When there are a plurality of steps connected to each of the transitions, steps are arranged from left to right and connected by a parallel branch. The display control unit 23 repeats this process to arrange all elements in a tree structure. When a grid is used, it suffices that each of subtrees has a required width. FIG. 6 is an example of a display in the display unit 3 of an SFC constituted by elements arranged in a tree structure.

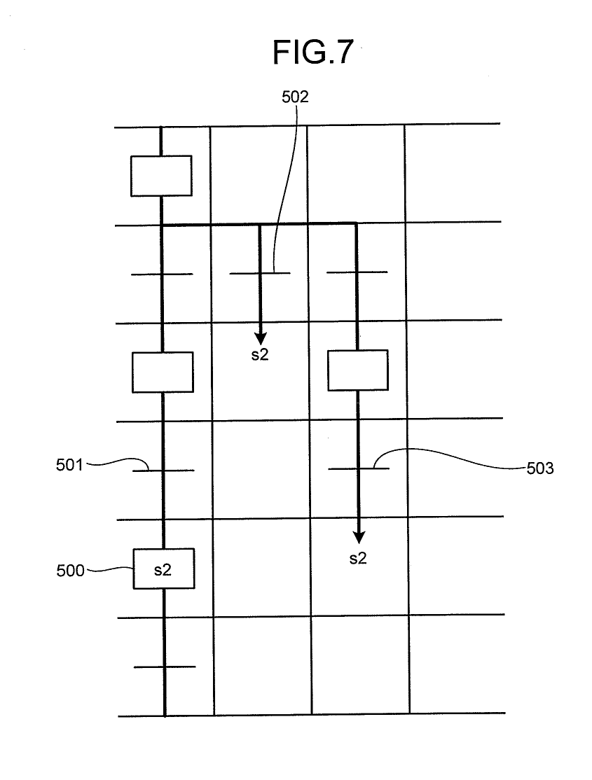

By using selective convergence and parallel convergence, steps or transitions including a plurality of preceding elements can appear in an SFC several times. In this case, the display control unit 23 needs only to draw a subtree including a subsequent element for only one of the elements appearing several times. For other parts, the display control unit 23 draws only the element and indicates that others are omitted, or draws a connection line with the drawn element. FIG. 7 is an example of an SFC drawing including steps appearing several times. A step 500 is allocated with a number “s2” on edit data, and an arrow pointing to s2 in FIG. 7 indicates that it is connected to an inlet of the step 500 allocated with this number. The step 500 includes, as preceding elements, a transition 501, a transition 502, and a transition 503. However, only a subtree connected to the transition 501 is drawn, and as for the transitions 502 and 503, it is only drawn that the step 500 follows, and the drawing of other subtrees are omitted.

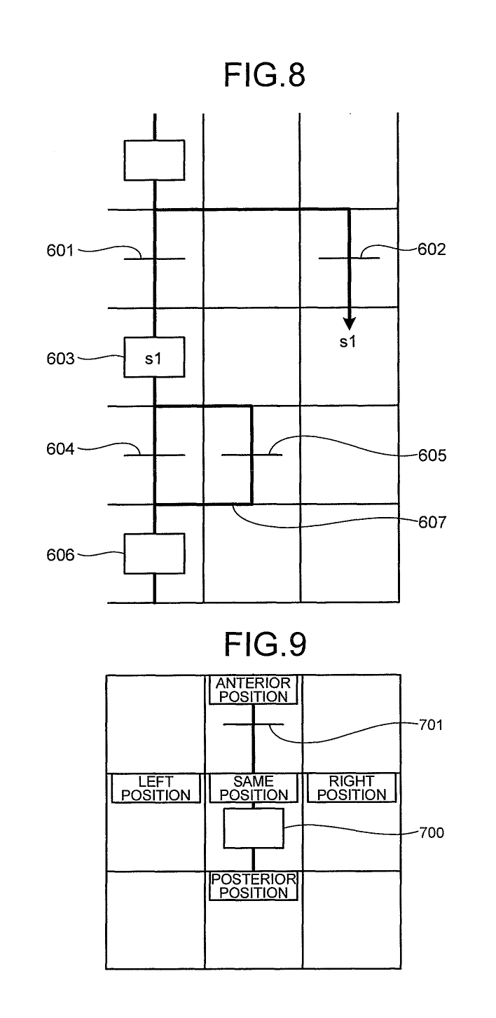

When one preceding step includes a plurality of transitions, if these transitions are arranged adjacent to each other, the display control unit 23 draws an SFC by using the selective convergence, and if not, the display control unit 23 draws the SFC by an abbreviated drawing. Even in these cases, the relation of the connection is the same. As for the parallel convergence, the display control unit 23 can determine whether to make an abbreviated drawing based on the same basis. FIG. 8 is an example of a drawing of a step including a plurality of preceding transitions. A step 603 is allocated with a number “s1” on edit data, and an arrow pointing to s1 in FIG. 8 indicates that it is connected to an inlet of the step 603 allocated with this number. Because a transition 601 and a transition 602 are not arranged adjacent to each other, a connection between the transition 602 and the step 603 is shown by an abbreviated drawing. On the other hand, a transition 604 and a transition 605 are arranged adjacent to each other. Therefore, the connection between the transition 605 and a step 606 is not omitted, and drawn by using a selective convergence 607. Although both connections are expressed differently, the relation of the connection is the same.

As described above, it is assumed that an SFC is mechanically created by the display control unit 23 based on the relation of the connection. That is, an editing operation using the input unit 1 is performed with respect to the SFC; however, an editing process is performed by the editing control unit 22 with respect to the relation of the connection, and the display control unit 23 creates the SFC based on the relation of the connection.

To create a tree structure, it is only necessary to specify an element to be processed and add an element subsequent thereto, and to specify an order of a plurality of subsequent elements (a horizontal alignment order).

An operation of the editing control unit 22 is explained next. The editing control unit 22 determines what process should be performed based on an operation performed via the input unit 1 and a relatively strong restriction held by a relation of a connection (a code stored in the rule storage unit 5). The restriction on a relation of a connection used here is as follows. (1) Steps and transitions appear alternately, and steps are not connected with each other and transitions are not connected with each other. (2) There is a case where a plurality of transitions follow one step. This is expressed as “selective branch” on an SFC. Furthermore, when a plurality of transitions precede one step, this is expressed as “selective convergence”. (3) There is a case where a plurality of steps follow one transition. This is referred to as “parallel branch”. When a plurality of steps precede one transition, this is expressed as “parallel convergence”.

From (1) described above, the editing control unit 22 can automatically determine that an element following a step is a transition, and an element following a transition is a step. From (2) and (3) described above, the editing control unit 22 can automatically determine that when a plurality of steps follow a transition, these are parallel branches, and when a plurality of transitions follow a step, these are selective branches.

Operations performed via the input unit 1 include an operation of specifying a certain element (a step or a transition) arranged on an SFC and inserting it into a relevant position, and an operation of specifying a certain element (a step or a transition) arranged on the SFC and deleting the element.

Furthermore, as the “relevant position” in operations, the editing control unit 22 defines “same position”, “anterior position”, “posterior position”, “right position”, and “left position”. FIG. 9 is a definition example of the relevant position in an operation. The editing control unit 22 defines a cell in which a specified part (in this case, a step 700) is arranged as the “same position”, an upper (anterior) cell of the cell in which the specified part is arranged as the “anterior position”, a left cell of the cell in which the specified part is arranged as the “left position”, a right cell of the cell in which the specified part is arranged as the “right position”, and a lower (posterior) cell of the cell in which the specified part is arranged as “posterior position”.

A case where an insertion of a new element is performed without specifying an element type is explained. As shown in FIG. 9, in a state with the elements being arranged, the step 700 is specified as a new-element insertion target element by an operation using the input unit 1, and a process performed by the editing control unit 22 when the new element is inserted into the relevant position (a position corresponding to the new-element insertion target element) is defined for each relevant position. A new-element inserting operation using the input unit 1 assumed in this example is, specifically, pressing a button representing shifting of a cursor to a relevant position and insertion of a new element, or drag and drop of a new insertion icon to a relevant location.

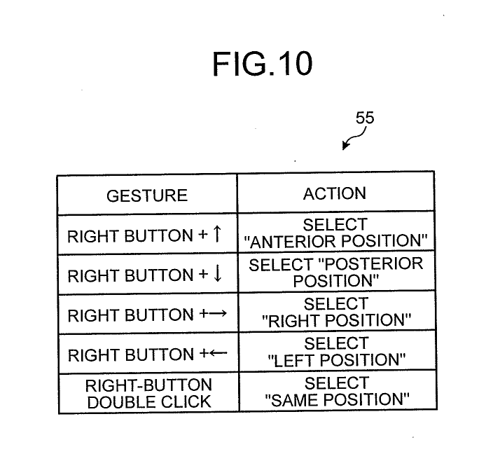

As a method of specifying a relevant position, it is possible to employ an input method by a mouse gesture. FIG. 10 is an example of a table that defines a correspondence between a gesture and an action. By storing a table 55 as shown in FIG. 10 in the rule storage unit 5 or the like, and specifying processing contents by the input processing unit 21 by referring to the table, an input by a mouse gesture can be realized. By employing the input method using a mouse gesture, the movement of a mouse is reduced, and thus even when there is a mouse cursor at a position away from a cell in which a new-element insertion target element is arranged, an operation of specifying a relevant position can be performed without moving the mouse cursor.

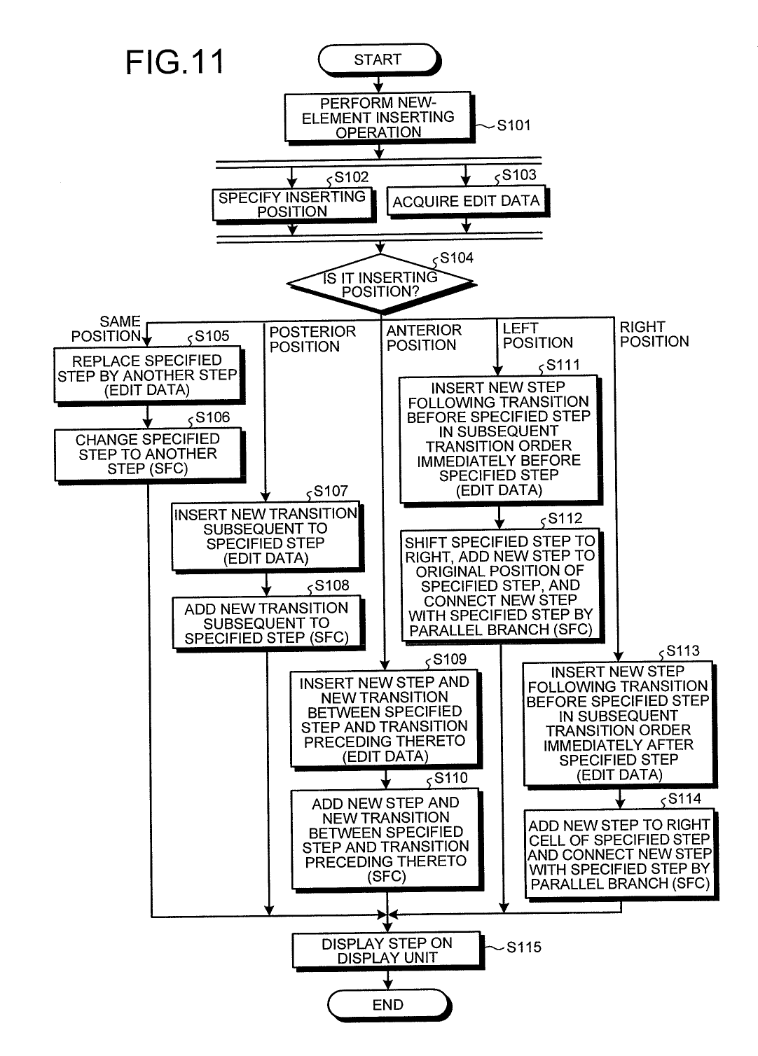

FIG. 11 is a flowchart of a processing flow when insertion of a new element is performed without specifying an element type. FIG. 11 represents a process when the step 700, among two elements (the step 700 and a transition 701) already arranged as shown in FIG. 9, is specified as a new-element insertion target element and a part is newly inserted. A user performs an operation of inserting a new element by using the input unit 1 (Step S101). The input processing unit 21 specifies a relevant position specified by the operation (Step S102). The editing control unit 22 then acquires edit data from the storage unit 4 (Step S103).

When the relevant position specified by the new-element inserting operation using the input unit 1 is the same position (Step S104/same position), the editing control unit 22 replaces the step 700 in edit data by another step (Step S105). The display control unit 23 changes the step 700 on an SFC to another step (Step S106), and displays the step on the display unit 3 (Step S115).

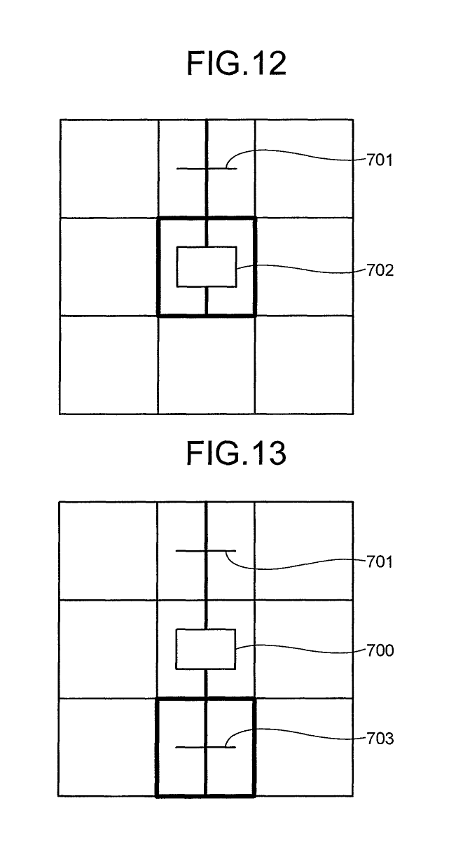

FIG. 12 is an example of an SFC to be displayed on the display unit 3 by the display control unit 23 based on a processing result when a new-element inserting operation is performed on the same position. FIG. 12 depicts an SFC of a case when a new-element inserting operation is performed on the same position in the SFC shown in FIG. 9. When a new-element inserting operation is performed on the same position, the editing control unit 22 deletes the connection between the transition 701 and the step 700. The editing control unit 22 then creates a new step (in this case, a step 702), and connects an outlet of the transition 701 with an inlet of the step 702. In this manner, when a new-element inserting operation is performed on the same position, the editing control unit 22 replaces the new-element insertion target element by another element of the same type. The display control unit 23 displays an SFC on the display unit 3 based on edit data in which the element is replaced in this manner.

When the relevant position specified by the new-element inserting operation using the input unit 1 is the posterior position (the next position) (Step S104/posterior position), the editing control unit 22 newly inserts a transition in a subsequent stage of (next to) the step 700 in edit data (Step S107). The display control unit 23 newly adds a transition below the step 700 in an SFC (Step S108), and displays the transition on the display unit 3 (Step S115).

FIG. 13 is an example of an SFC to be displayed on the display unit 3 by the display control unit 23 based on a processing result when a new-element inserting operation is performed on the posterior position. FIG. 13 depicts an SFC of a case when a new-element inserting operation is performed on the posterior position in the SFC shown in FIG. 9. When a new-element inserting operation is performed on the posterior position, the editing control unit 22 newly creates a transition, which is an element of a different type from the new-element insertion target element (in this case, a transition 703), and connects an outlet of the step 700 with an inlet of the transition 703. The display control unit 23 displays an SFC based on edit data in which a new element is added in this manner on the display unit 3.

When the relevant position specified by the new-element inserting operation using the input unit 1 is the anterior position (Step S104/anterior position), the editing control unit 22 inserts a new step and a new transition between the transition 701 and the step 700 in edit data (Step S109). The display control unit 23 newly adds a new step and a new transition between the transition 701 and the step 700 in an SFC (Step S110), and displays them on the display unit 3 (Step S115).

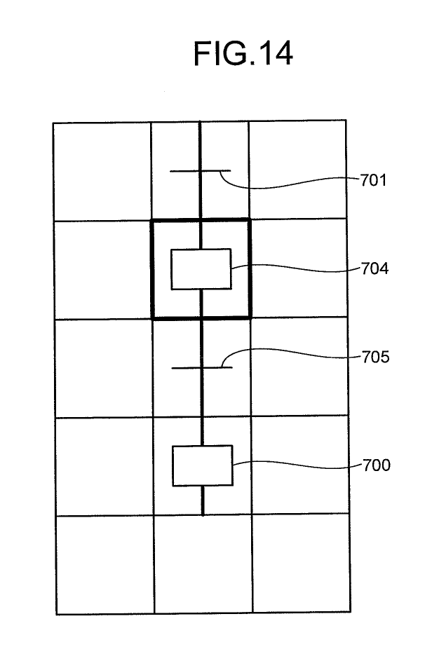

FIG. 14 is an example of an SFC to be displayed on the display unit 3 by the display control unit 23 based on a processing result when a new-element inserting operation is performed on the anterior position. FIG. 14 depicts an SFC of a case when a new-element inserting operation is performed on the anterior position in the SFC shown in FIG. 9. When a new-element inserting operation is performed on the anterior position, the editing control unit 22 newly creates a step, which is an element of the same time as the new-element insertion target element (in this case, a step 704) and a transition, which is an element of a different type from the specified element (in this case, a transition 705), and connects an outlet of the transition 701 with an inlet of the step 704, an outlet of the step 704 with an inlet of the transition 705, and an outlet of the transition 705 with an inlet of the step 700, respectively. The new-element inserting operation on the anterior position is an insertion of an element preceding the new-element insertion target element and inserts a set of two types of elements. The display control unit 23 displays an SFC based on edit data in which two types of elements are added as a set in this manner on the display unit 3.

When the relevant position specified by the new-element inserting operation using the input unit 1 is the left position (Step S104/left position), the editing control unit 22 inserts a new step as a subsequent step of the transition 701 in the edit data, so that the subsequent transition order becomes immediately before the step 700 (Step S111). The display control unit 23 shifts the step 700 in an SFC to a right cell, adds a step to be newly inserted to the cell in which the step 700 has been arranged, connects the step 700, the newly inserted step, and the transition 701 with each other by a parallel branch (Step S112), and displays them on the display unit 3 (Step S115).

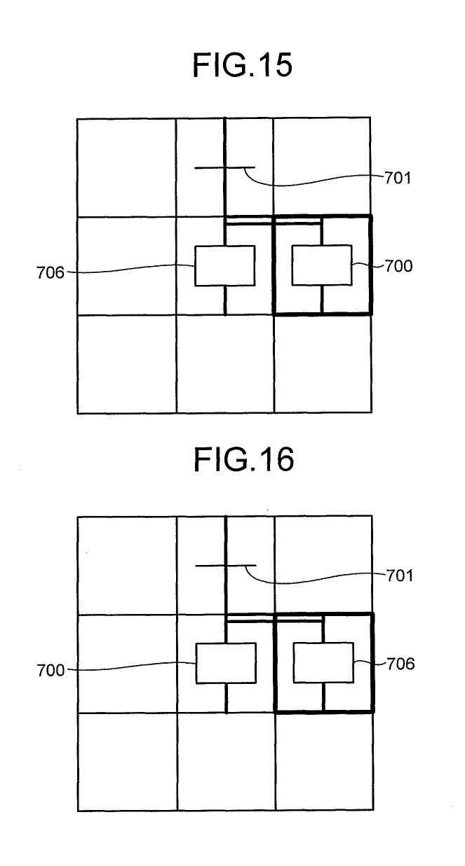

FIG. 15 is an example of an SFC to be displayed on the display unit 3 by the display control unit 23 based on a processing result when a new-element inserting operation is performed on a left position. FIG. 15 depicts an SFC of a case when a new-element inserting operation is performed on the left position in the SFC shown in FIG. 9. When a new-element inserting operation is performed on the left position, the editing control unit 22 newly creates a step, which is an element of the same time as the new-element insertion target element (in this case, a step 706), and connects an outlet of the transition 701 with an inlet of the step 706. The editing control unit 22 sets the subsequent transition order to immediately before the step 700. The display control unit 23 displays an SFC based on edit data in which the element is added in this manner on the display unit 3. Because the elements of the same type are arranged adjacent to each other, the step 700 and the step 706 are drawn as a parallel branch.

When the relevant position specified by the new-element inserting operation using the input unit 1 is the right position (Step S104/right position), the editing control unit 22 inserts a new step as a subsequent step of the transition 701 in the edit data, so that the subsequent transition order becomes immediately after the step 700 (Step S113). The display control unit 23 adds a step to be newly inserted to the right cell of the step 700, connects the transition 701, the step 700, and the newly inserted step with each other by a parallel branch (Step S114), and displays them on the display unit 3 (Step S115).

FIG. 16 is an example of an SFC to be displayed on the display unit 3 by the display control unit 23 based on a processing result when a new-element inserting operation is performed on a right position. FIG. 16 depicts an SFC of a case when a new-element inserting operation is performed on the right position in the SFC shown in FIG. 9. When a new-element inserting operation is performed on the right position, the editing control unit 22 newly creates a step, which is an element of the same time as the new-element insertion target element (in this case, the step 706), and connects an outlet of the transition 701 with an inlet of the step 706. The editing control unit 22 sets the subsequent transition order to immediately after the step 700. The display control unit 23 displays an SFC based on the edit data in which the element is added in this manner on the display unit 3. Because the elements of the same type are arranged adjacent to each other, the step 700 and the step 706 are drawn as a parallel branch.

As described above, insertion of a transition following steps and insertion of a parallel branch become possible. While a case where a specified element is a step is explained here as an example, the same is true for a case where a transition is specified, and insertion of a step following a transition and insertion of a parallel branch are possible.

As for deletion, the editing control unit 22 deletes a connection with an element preceding a new-element insertion target element. The reason for the element itself not being deleted is that, when there are a plurality of preceding elements, the relation with these elements should be maintained. When there is no preceding element, the editing control unit 22 can delete the element itself.

In the new-element inserting operation described above, it is not specified “what” is to be inserted in the operation using the input unit 1, and the editing control unit 22 automatically determines an element to be inserted. However, by additionally specifying a portion corresponding to “what”, a process to be performed by a single operation can be added to form an already-arranged element connecting operation. As an example of this operation, a similar operation with respect to an already-arranged element is defined first. As a specific example of the operation using the input unit 1, drag and drop of a second already-arranged element to a position relevant to a first already-arranged element can be mentioned.

By specifying a certain element (a step or a transition) arranged on an SFC by the operation using the input unit 1, the editing control unit 22 inserts an “already arrange element” into a relevant position. A process performed in practice is equivalent to a process in which a process corresponding to “generation of a new step or transition” described above is omitted, and only a connection to the already-arranged element is performed.

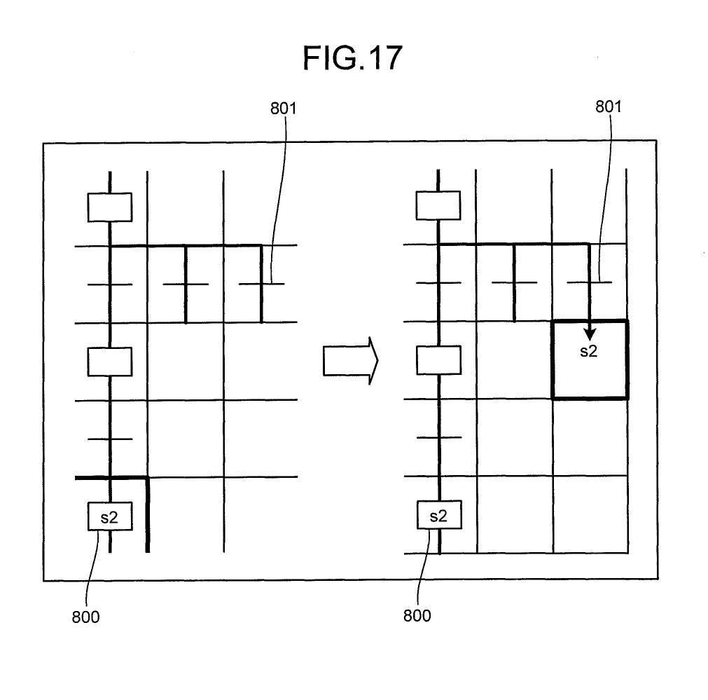

FIG. 17 is an example of a connecting process of the already-arranged elements. When it is desired to cause a step 800 (the second already-arranged element) to follow a transition 801 (the first already-arranged element), the step 800 is dragged and dropped to a cell at a position after the transition 801 by the already-arranged element connecting operation using the input unit 1. Accordingly, a process of connecting an outlet of the transition 801 with an inlet of the step 800 is performed by the editing control unit 22. In this example, the step 800 is allocated with a number of “s2” on edit data, and an arrow pointing to s2 in FIG. 17 indicates that it is connected to the inlet of the step 800 allocated with this number.

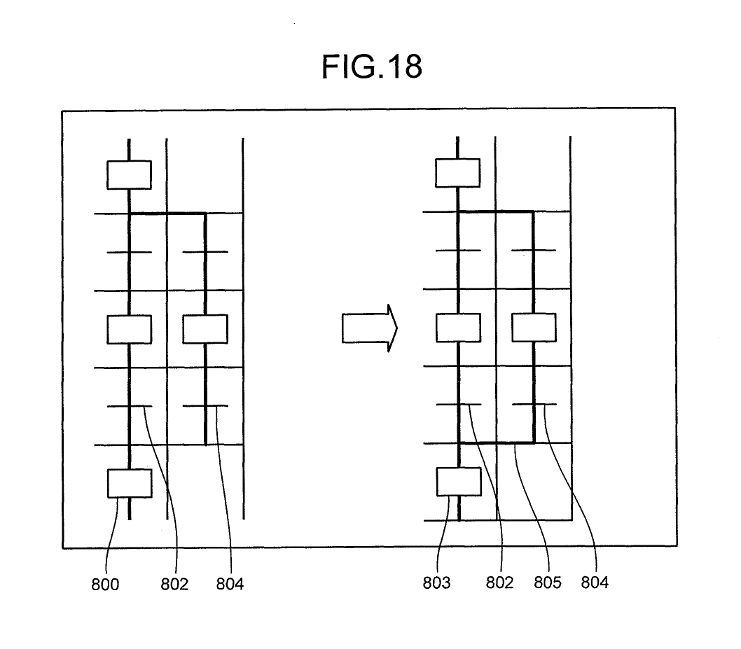

FIG. 18 is another example of the connecting process of the already-arranged elements. In FIG. 18, when a step 803 following a transition 802 is dragged and dropped to a transition 804 in a cell adjacent to the transition 802 by the already-arranged element connecting operation using the input unit 1, the editing control unit 22 generates a selective convergence 805. Similarly, when an operation of dragging and dropping a transition following a step to a step in an adjacent cell is performed by using the input unit 1, the editing control unit 22 generates a parallel convergence.

In the present embodiment, because it is not required to specify “what” in the operation using the input unit 1, additional information can be held by this portion.

For example, while a step has a process, as a typical example of this process, there is a process in which the value of a certain device is only set according to an activation state (“Boolean action” referred to in the IEC standard). Furthermore, transition conditions of the transition include a condition in which if the value of a certain device is true, the condition is established, and if not, it is not established. In each case, only by specifying a device to be processed to a portion corresponding to “what” by using the input unit 1, the editing control unit 22 can insert and connect an element including processes or transition conditions.

Similarly to the insertion of a new element or an already-arranged element, an element and a process or transition condition in this element can be input by a single operation, by inserting a device to a corresponding relevant position by an operation using the input unit 1.

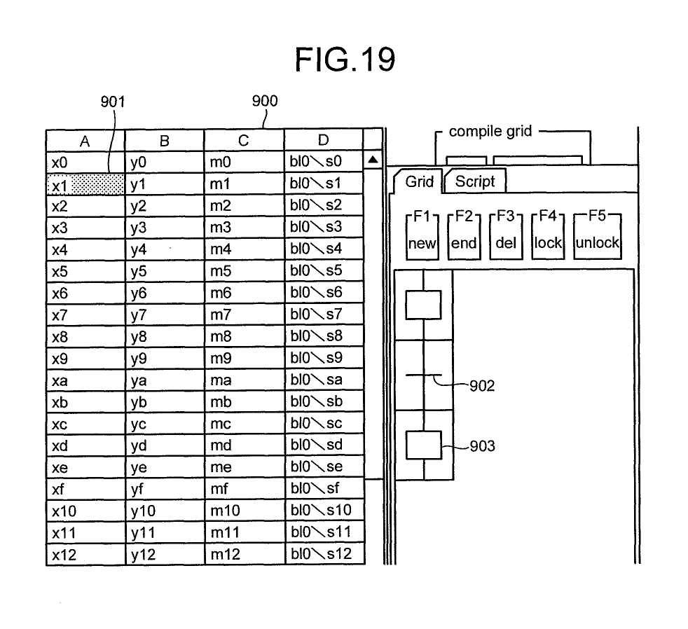

FIG. 19 is an example of an SFC editing screen. In a GUI shown in FIG. 19, a device list 900 is displayed on the left. When an operation of dragging and dropping an icon 901 of a device x1 to a position below a target transition 902 is performed by using the input unit 1, the editing control unit 22 generates a step (in this case, a step 903) based on information of a target type and posterior position, and connects the step 903 to the transition 902. Furthermore, the editing control unit 22 can perform editing as a process of the step 903 such that the value of the device x1 is set to an active state of the step 903.

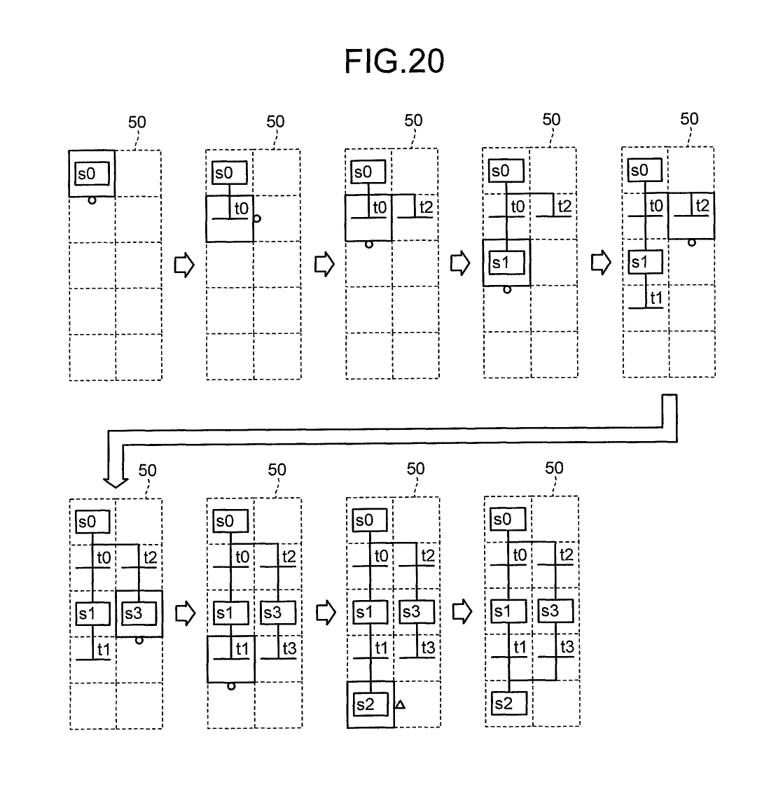

FIG. 20 is a screen transition example in the sequence program creating apparatus according to the present embodiment. In respective states in FIG. 20, a cell to be operated is indicated by a thick frame, a relevant position is indicated by a circle, and a dropping point at the time of dragging and dropping the cell to be operated is indicated by a triangle. A process of arranging steps s0 to s3 and transactions t0 to t3 on an editor screen 50 is completed by nine operations including an operation of arranging the step s0. In each of the operations, it is not required to specify what is inserted, and an operation therefor (by a tool bar or a function key) can be omitted. In addition, when processes and transition conditions of these elements are for a single device, setting of these processes and transition conditions can be included in the nine operations mentioned above.

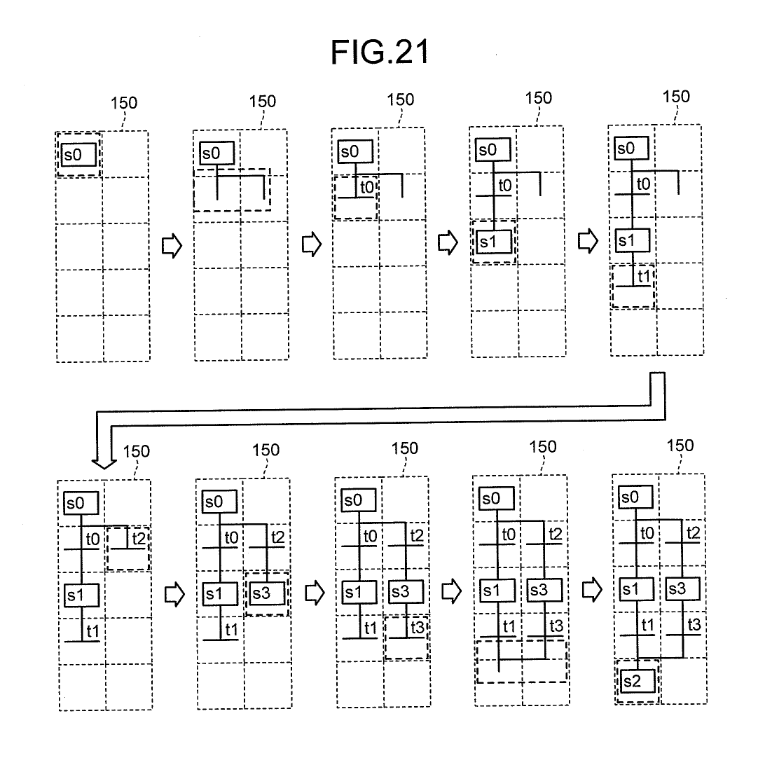

FIG. 21 is a screen transition example in a conventional sequence program creating apparatus. In respective states in FIG. 21, an element inserted by an inserting operation immediately before is indicated by being encircled by a thick broken line. To insert respective elements similar to those in FIG. 20 in an editor screen 150, ten inserting operations are required including a connection line, which is a selective branch/selective convergence part. In each of the operations, it is required to select what is inserted (by using a tool bar or a function key). Each of the steps and transitions include processes and transition conditions accompanied therewith, and these elements need to be set separately.

In simple operation examples such as those shown in FIG. 20 and FIG. 21, the difference in the number of operations is hardly recognizable. However, when insertion and the like are performed with respect to an already described SFC, in conventional techniques, there is required a labor to shift a right or posterior part from an inserting position and reconnect a connection line. In the present embodiment, because a relation of a connection is directly edited, operations such as shifting elements are not required at all, and thus the number of operations is largely reduced.

The SFC created by the sequence program creating apparatus according to the present embodiment is constituted only by elements arranged according to a code, and thus creation of an inexecutable sequence program (conversion to an inexecutable code) can be prevented.

As described above, according to the present embodiment, the number of operations required for editing an SFC can be reduced, and it is possible to prevent an arrangement of elements, which does not follow the code.

### Second Embodiment

In the first embodiment, a “relevant position” is specified by using a cell in which a specified element is arranged and a cell adjacent thereto. However, when another element has been already arranged in the cell adjacent to the cell in which a specified element is arranged, the meaning of the operation becomes ambiguous, and thus an arrangement needs to be made in order to vacate the arrangement position.

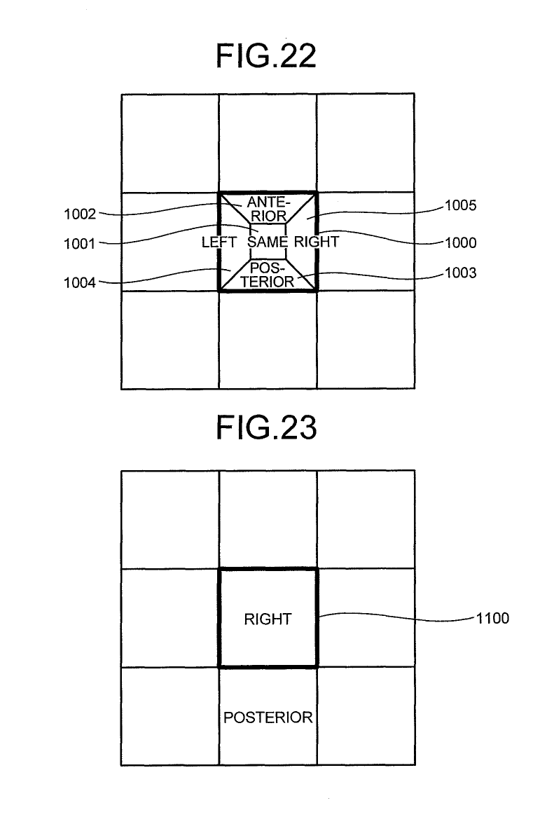

Therefore, in a second embodiment of the present invention, the editing control unit 22 divides a cell into a plurality of areas and defines a relevant position in a cell in which the specified element is arranged. FIG. 22 is an example in which a cell is divided into a plurality of areas to define a relevant position. A cell 1000 is divided into an area 1001 corresponding to the same position, an area 1002 corresponding to the anterior position, an area 1003 corresponding to the posterior position, an area 1004 corresponding to the left position, and an area 1005 corresponding to the right position.

In the present embodiment, because a relevant position can be specified by an operation in the cell in which the specified element is arranged, even when a part has been already arranged in an adjacent cell, the meaning of the operation does not become ambiguous. However, by dividing the cell into a plurality of areas, the operability of the operation of specifying the relevant position is degraded, and a processing load of the control unit 2 increases with the division of the cell. Therefore, it is preferable to apply either one of the first and second embodiments as appropriate, based on which one of the operability or the processing load of or unambiguity of the operation of the control unit 2 is given a priority. In addition, the first and second embodiments can be used together so that cell division is made effective at all times and the specification of the relevant position by using an adjacent cell can be made effective only when the cell is available.

Furthermore, as for the specification of the relevant position by using the adjacent cell, the relevant position can be allocated to an adjacent cell unsymmetrically according to the usage frequency thereof. FIG. 23 is an example in which a relevant position is allocated to an adjacent cell. For example, when replacement of an element is not performed frequently, as shown in FIG. 23, a cell 1100 in which a specified element is arranged can be associated with the right position.

### INDUSTRIAL APPLICABILITY

As described above, the sequence program creating apparatus according to the present invention is suitable to create a sequence program that can be executed by arranging elements according to a code.

### REFERENCE SIGNS LIST

1 input unit
2 control unit
3 display unit
4 storage unit
5 rule storage unit
10 sequence program creating apparatus
21 input processing unit
22 editing control unit
23 display control unit
50 editor screen
55 table
100, 103, 200, 206, 301, 302, 304, 305, 402, 404, 405, 500, 603, 606, 700, 702, 704, 706, 800, 803, 903 step
101, 201, 202, 204, 205, 300, 306, 400, 401, 406, 501, 502, 503, 601, 602, 604, 605, 701, 703, 705, 801, 802, 804, 902 transition
102 connection line
203 selective branch
207, 403, 607, 805 selective convergence
303 parallel branch
307, 407 parallel convergence
900 device list
901 icon of device x1
1000, 1100 cell
1001 area corresponding to same position
1002 area corresponding to anterior position
1003 area corresponding to posterior position
1004 area corresponding to left position
1005 area corresponding to right position

1. A sequence program creating apparatus that creates a sequence program to be executed by a programmable logic controller by causing a user to perform an operation of editing a sequential function chart (SFC) expressed by a plurality of elements and a connecting state thereof on an editing screen, the sequence program creating apparatus comprising:
a rule storage unit that stores therein a code of the SFC; and
an editing control unit that, when a new-element inserting operation for newly inserting the element into the SFC is performed on the editing screen, adds data corresponding to the new element to data of the sequence program, based on a type of the already-arranged element specified as a new-element insertion target element by the new-element inserting operation, a position with respect to the new-element insertion target element, and a code of the SFC stored in the rule storage unit.

2. The sequence program creating apparatus according to claim 1, wherein, when an already-arranged element connecting operation for connecting the already-arranged elements with each other is performed on the editing screen, the editing control unit updates data of the sequence program by connecting the already-arranged element specified as a first already-arranged element and the already-arranged element specified as a second already-arranged element with each other by the already-arranged element connecting operation, based on respective types of the first already-arranged element and the second already-arranged element, a position with respect to the first already-arranged element, and a code of the SFC stored in the rule storage unit.

3. The sequence program creating apparatus according to claim 1, wherein
the new-element inserting operation includes an operation of selecting a device from a list of a device connected to the programmable logic controller and an operation of arranging the selected device to the specified position, and
the editing control unit sets one of an acquisition of a device value from the device and a change of the device value, as a condition relevant to the new element to be added to data of the sequence program, according to a type of the new-element insertion target element.

4. The sequence program creating apparatus according to claim 1, wherein the editing control unit determines a position with respect to the new-element insertion target element based on the combination of a cell in which the new-element insertion target element and a cell at anterior, posterior, left, or right of the cell is selected.

5. The sequence program creating apparatus according to claim 1, wherein the editing control unit divides a cell in which the new-element insertion target element is arranged into a plurality of areas, and determines a position with respect to the new-element insertion target element based on which one of the divided areas is selected.
